(19) United States
(12) Patent Application Publication
(10) Pub. No.: US 2025/0085430 A1
(43) Pub. Date: Mar. 13, 2025

(54) DETECTION OF A TRANSLUCENT MATTER BASED ON SECONDARY LIDAR RETURNS

(71) Applicant: GM Cruise Holdings LLC, San Francisco, CA (US)

(72) Inventors: Mauricio Flores Rios, San Jose, CA (US); Cheng-An Hou, San Ramon, CA (US); Xianming Liu, San Carlos, CA (US); Sijia Chen, Santa Clara, CA (US)

(21) Appl. No.: 18/466,761

(22) Filed: Sep. 13, 2023

(51) Int. Cl. G01S 17/931; G01S 7/481

(52) U.S. Cl. CPC G01S 17/931; G01S 7/4817

(57) ABSTRACT

Systems and techniques are provided for detecting a translucent matter based on light detection and ranging (LIDAR) returns. An example method can include receiving at least two LIDAR returns associated with a LIDAR beam transmitted by a LIDAR device. The two LIDAR returns include a primary return comprising a first portion of the LIDAR beam reflected from a matter and a secondary return comprising a second portion of the LIDAR beam reflected from additional matter. The example method can further include determining a distance difference between a first position of the matter along the first path and a second position of the additional matter along the second path, comparing the distance difference with a threshold, and based on the comparison between the distance difference and the threshold, determining whether the additional matter is a non-translucent matter or a translucent matter.

### BACKGROUND

### 1. Technical Field

The present disclosure generally relates to light detection and ranging (LIDAR) sensors. For example, aspects of the present disclosure relate to techniques and systems for detecting certain matter based on secondary ranging sensor returns.

### 2. Introduction

Sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. For example, a light ranging and detection (LIDAR) sensor can be used to determine ranges (variable distance) of one or more targets by directing a laser to a surface of an entity (e.g., a person, an object, a structure, an animal, etc.) and measuring the time for light reflected from the surface to return to the LIDAR.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some examples of the present disclosure;

FIG. 2 illustrates an example system environment for detecting a translucent matter based on LIDAR returns, according to some examples of the present disclosure;

FIG. 3A illustrates an example scene for detecting a translucent matter based on LIDAR returns, according to some examples of the present disclosure;

FIG. 3B illustrates an example waveform of LIDAR returns, according to some examples of the present disclosure;

FIG. 4 illustrates an example system for detecting a translucent matter based on LIDAR returns using a machine learning model, according to some examples of the present disclosure;

FIG. 5 is a flowchart illustrating an example process for detecting a translucent matter based on LIDAR returns, according to some examples of the present disclosure; and

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, sensors are commonly integrated into a wide array of systems and electronic devices. The sensors allow users to obtain sensor data that measures, describes, and/or depicts one or more aspects of a target such as an object, a scene, a person, and/or any other targets. AVs can use the sensors to collect sensor data that the AVs can use for operations such as perception (e.g., object detection, event detection, tracking, localization, sensor fusion, point cloud processing, image processing, etc.). For example, AVs may use one or more light ranging and detection (LIDAR) sensors, time-of-flight (TOF) sensors, and/or radio detection and ranging (RADAR) sensors to detect and identify surrounding objects (e.g., vehicles, pedestrians, buildings, traffic signals, cyclists, etc.). In some cases, an AV may use the data from LIDAR sensors, TOF sensors, and/or RADAR sensors to predict the trajectory of objects within its environment and to help maneuver the AV (e.g., stop, accelerate, turn, etc.).

In a LIDAR sensor (and a TOF sensor), a LIDAR sensor emits light waves (also referred to as beams or laser signals) from a laser into the environment. The signals bounce off the surface of surrounding object(s) and return to the LIDAR sensor. The LIDAR sensor receives and processes the returned reflection(s) (e.g., received waveform energy) and outputs the LIDAR return(s). Some translucent matters (e.g., vapor, steam, dust cloud, water splash, fog, translucent objects that allow some light to pass through such objects, other particle clouds, etc.) are difficult to detect with a ranging sensor, such as a LIDAR sensor or a TOF sensor, because the translucent matters do not always cause strong reflections of light signals from such sensors.

Described herein are systems, apparatuses, processes (also referred to as methods), and computer-readable media (collectively referred to as “systems and techniques”) for determining certain matters, such as translucent matter, based on secondary returns of a light-based ranging sensor (e.g., LIDAR, TOF sensor). For example, the systems and techniques can leverage features from a secondary LIDAR return (or secondary TOF sensor return), which may have a lower signal intensity than a primary LIDAR return and determine whether the secondary return is generated by a reflection from a translucent matter (e.g., vapor, steam, water splash, fog, rain, dust, etc.).

In some examples, the systems and techniques described herein can determine a distance difference between a first position associated with a primary return (e.g., a first return associated with a light pulse emitted by a sensor) and a second position associated with a secondary return (e.g., one or more additional returns that are received after a primary return (or that have a lower signal intensity than a primary return) and are associated with the same light pulse emitted by a sensor as the primary return). For example, the systems and techniques can receive at least two LIDAR returns (e.g., a primary return and a secondary return) that are associated with a LIDAR beam transmitted by a LIDAR sensor where the primary return has a higher signal intensity than the secondary return. The systems and techniques can determine a distance difference between a first position associated with the primary return and a second position associated with the secondary return. As follows, based on a comparison between the distance difference and a threshold, the systems and techniques can determine whether a target that generated the secondary return is non-translucent matter or translucent matter.

Aspects of the disclosed technology can improve perception, and consequently prediction, and planning systems of an AV with a detection of a translucent matter that may present in the surrounding environment of an AV, for example in an inclement weather condition. Instead of using a secondary LIDAR return for an additional point(s) in a LIDAR point cloud, the systems and techniques of the disclosed technology may leverage the features of a secondary LIDAR return to improve the detection accuracy of a point cloud based on a primary LIDAR return.

The systems and techniques described herein are generally described in an example context of autonomous vehicles. However, the examples involving autonomous vehicles are merely illustrative examples provided for explanation purposes. That is, the systems and techniques described herein can be used in any other contexts that implement light-based ranging sensors, such as LIDARs and/or TOF sensors. For example and without limitation, the systems and techniques described herein can be implemented in other automation contexts (e.g., aircrafts, boats, robotics, etc.), extended reality (e.g., augmented reality, virtual reality, mixed reality, video passthrough, etc.) contexts, etc. Moreover, while the use of secondary returns is described herein in the context of LIDARs, such use of secondary returns can also be used in contexts involving other light-based ranging sensors, such as TOF sensors. The LIDAR examples herein are non-limiting examples provided for explanation purposes.

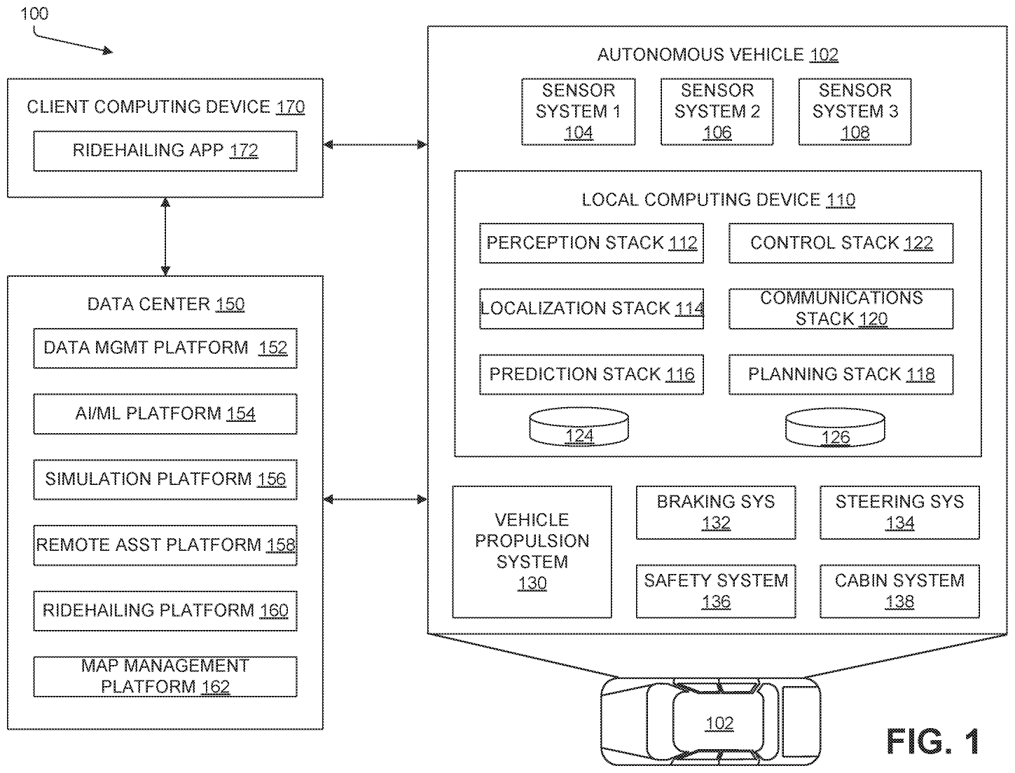

Various examples of the systems and techniques for detecting a translucent matter based on LIDAR returns are illustrated in FIG. 1 through FIG. 5 and described below.

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridehailing service (e.g., a ridesharing service), a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridehailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridehailing/ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridehailing service (e.g., a ridesharing service) via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. The client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the ridehailing application 172 (e.g., client application) to enable passengers to view the AV 102 in transit en route to a pick-up or drop-off location, and so on.

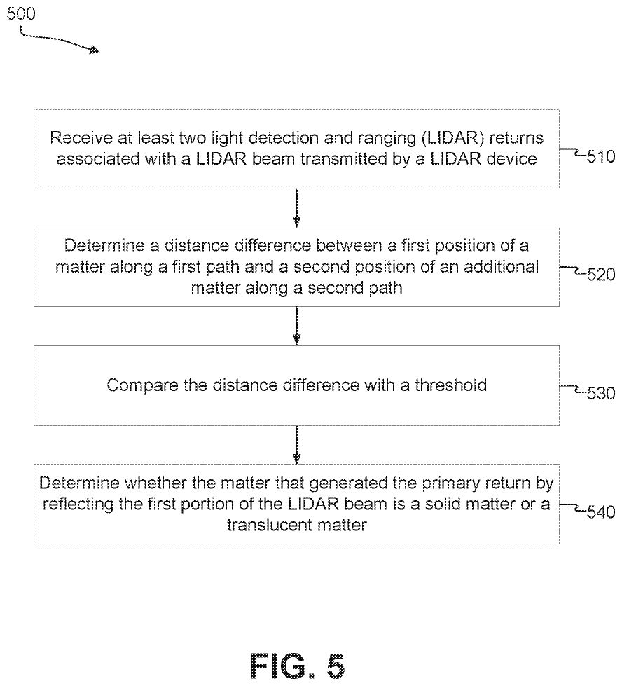

While the autonomous vehicle 102, the local computing device 110, and the AV environment 100 are shown to include certain systems and components, one of ordinary skill will appreciate that the autonomous vehicle 102, the local computing device 110, and/or the AV environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 5.

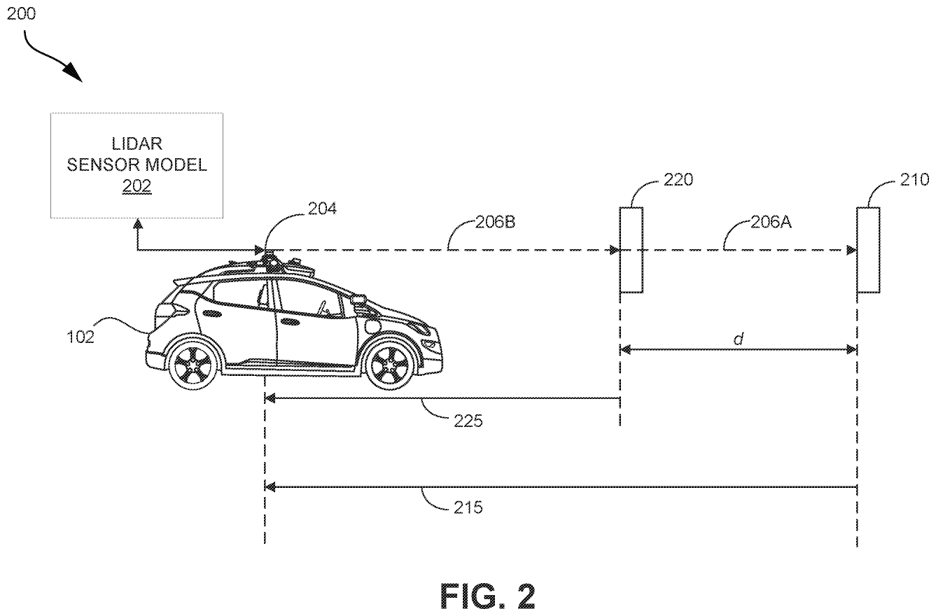

FIG. 2 illustrates an example system environment 200 for detecting a translucent matter based on LIDAR returns. In some instances, LIDAR sensor model 202 can be used to determine whether a translucent matter is present in a scene (e.g., the surrounding environment of AV 102) based on LIDAR returns such as a first return 215 and/or a second return 225 that are associated with a LIDAR sensor 204. In some examples, LIDAR sensor 204 may correspond to a LIDAR sensor that is used as part of sensor systems 104-108 as illustrated in FIG. 1. Moreover, while this example and other examples below refer to a LIDAR sensor and LIDAR returns, the principles and techniques described herein can be used in other contexts involving other light-based ranging sensors, such as TOF sensors. The LIDAR examples herein are non-limiting examples provided for explanation purposes.

In some approaches, LIDAR sensor model 202 can be implemented within a sensor system of AV 102 (e.g., sensor systems 104-108), local computing device 110 such as a perception stack 112, or a remote system that may communicate with AV 102 or LIDAR sensor 204. In other approaches, LIDAR sensor model 202 can be implemented with a sensor system in another context such as, for example and without limitation, another automation context, an extended reality context, or any context that uses light-based ranging sensors.

In some examples, LIDAR sensor 204 can emit a beam of light and receive multiple LIDAR returns (e.g., a first return 215 and a second return 225) from that beam of light (e.g., beam 206). LIDAR sensor model 202 can receive the multiple LIDAR returns (e.g., a first return 215 and a second return 225), which are associated with a first portion of beam 206A and a second portion of beam 206B (collectively, beam 206). The second portion of beam 206B is an extension of the first portion of beam 206A. For example, the first portion of beam 206A and the second portion of beam 206B follow the same angle from LIDAR sensor 204. The LIDAR sensor 204 can emit beam 206 (e.g., laser signal), which would hit first target 210 and/or second target 220. As follows, beam 206 bounces off (e.g., reflects from) the surface of first target 210 and/or second target 220 and returns to LIDAR sensor 204. The LIDAR sensor 204 processes the returned reflection(s) (e.g., received waveform energy) and outputs LIDAR returns such as first return 215 that corresponds to the reflection of first target 210 and second return 225 that corresponds to the reflection of second target 220.

In some aspects, LIDAR sensor model 202 can determine a distance difference (d) between a position of first target 210 and a position of second target 220. For example, the position of first target 210 can be determined based on first return 215 (e.g., measured time/between emitting beam 206 and receiving of returned reflection from first target 210) and the position of second target 220 can be determined based on second return 225 (e.g., measured time/between emitting beam 206 and receiving of returned reflection from second target 220).

In some aspects, LIDAR sensor model 202 can compare the distance difference (d) with a predetermined threshold. When beam 206 hits a translucent matter (e.g., vapor, steam, water splash, fog, rain, dust, translucent object, particle cloud, etc.), a portion of photons in the light signal can reflect off the translucent matter while the other photons can pass through the translucent matter. In other words, since the translucent matter does not cause strong reflections of LIDAR signals, some translucent matters may allow LIDAR beam 206 to continue its path and produce additional returns (e.g., first return 215) with a new position at another matter (e.g., first target 210), range, and intensity. In some examples, LIDAR sensor model 202 can determine whether second target 220 is a translucent matter that had allowed beam 206 to pass through, which then is reflected from the surface of first target 210 based on a comparison between the distance difference (d) and a threshold (e.g., 2 cm).

In some examples, if the distance difference (d) is below a threshold, LIDAR sensor model 202 may determine that second target 220 is a non-translucent matter. For example, if the distance difference (d) between the position of second target 220 and the position of first target 210 is small or zero, LIDAR sensor model 202 may determine that second target 220 is likely the same matter as first target 210 since the second portion of beam 206B was not able to travel far relative to the first portion of beam 206A and/or first target 210. In some examples, if the distance difference (d) is below a threshold, LIDAR sensor model 202 may deem the point associated with second return 225 in the point cloud as noise.

In some aspects, if the distance difference (d) exceeds a threshold, LIDAR sensor model 202 may determine that second target 220 is a translucent matter such as, for example and without limitation, a translucent object, vapor, steam, water splash, fog, rain, and dust. As follows, LIDAR sensor model 202 may, in response to determining that second target 220 is a translucent matter, transmit an instruction to a computing device associated with AV 102 so that AV 102 may drive through the translucent second target 220.

In some instances, if second target 220 is a translucent matter, LIDAR sensor model 202 can provide the information associated with the translucent second target 220 to perception stack 112, prediction stack 116, and/or planning stack 118. For example, a LIDAR data point cloud that is mapped based on primary LIDAR returns may be updated to reflect that second target 220 is a translucent matter (e.g., generating points for translucent second target 220).

In some examples, LIDAR sensor model 202 can provide the information associated with the translucent second target 220 to control systems of AV 102. For example, one or more navigation parameters can be adjusted to adapt to navigating through or near the translucent second target 220 (e.g., decelerating, turning headlights on, etc.) in the scene.

In some aspects, LIDAR sensor model 202 can include one or more machine learning algorithms, which may be trained to learn the features/characteristics of a matter that has generated a secondary LIDAR return (e.g., translucency) from a relative relationship between a primary return (e.g., first return 215) and a secondary return (e.g., second return 225) such as a distance difference (d). For example, LIDAR returns (e.g., first return 215 and second return 225 that are associated with LIDAR beam 206) can be provided to a machine learning model, which is configured to generate a determination of whether second target 220 that generated second return 225 is a non-translucent matter or a translucent matter.

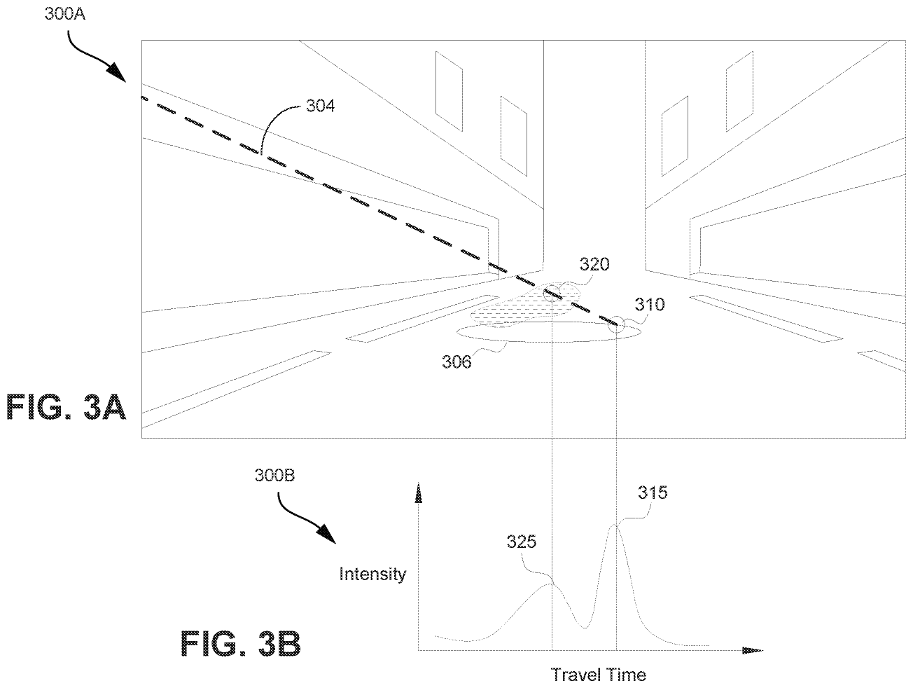

FIG. 3A illustrates an example scene 300A for detecting a translucent matter (e.g., vapor 320) based on LIDAR returns. FIG. 3B illustrates an example waveform 300B of corresponding LIDAR returns of FIG. 3A. In an illustrative example of scene 300A, a laser signal 304 (similar to beam 206 as illustrated in FIG. 2) is transmitted by a LIDAR device (not shown), such as LIDAR sensor 204. The laser signal 304 hits the surface of vapor 320 coming out of a pothole 306 in this example, and continues along its path and hits concrete ground 310. As shown in FIG. 3B, primary return 315 has a higher signal intensity than secondary return 325 since some photons of laser signal 304 may pass through vapor 320 and therefore, the reflection(s) of LIDAR signal from vapor 320 may be weaker than the reflection(s) of other matter such as non-translucent objects.

As described previously, the systems and techniques of the present disclosure (e.g., LIDAR sensor model 202 as illustrated in FIG. 2) can determine a distance difference between vapor 320 and concrete ground 310 based on primary return 315 and secondary return 325. For example, primary return 315 can be used to determine a location of concrete ground 315 and secondary return 325 can be used to determine a location of vapor 320. The location of vapor 320 and concrete ground 310 can be compared to determine a distance difference between vapor 320 and concrete ground 310. As follows, based on a comparison between the distance difference and a predetermined threshold, the systems and techniques can determine that vapor 320 is a translucent matter. For example, if the distance difference is above a predetermined threshold, the systems and techniques described herein can determine that vapor 320 is a translucent matter. Alternatively, if the distance difference is below the predetermined threshold, the systems and techniques described herein can determine that the target associated with secondary return 325 (in this example, vapor 320) is not a translucent matter.

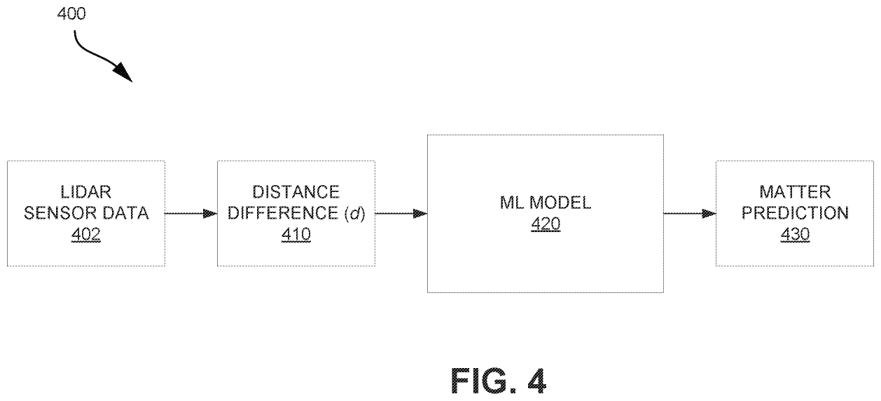

FIG. 4 illustrates an example system 400 for detecting a translucent matter based on LIDAR returns using a machine learning model. For example, LIDAR sensor model 202 as illustrated in FIG. 2 may implement a machine-learning model (e.g., ML model 420), which is configured to generate output (e.g., matter prediction 430 or prediction and/or detection of a translucent matter) given LIDAR sensor data 402 such as distance difference (d) 410 (e.g., distance difference d between a position of first target 210 and a position of second target 220 as illustrated in FIG. 2).

As previously described, LIDAR sensor data 402 can be collected by LIDAR sensor 204 when a beam of light is emitted and one or more LIDAR returns are received from that beam of light. The LIDAR sensor data 402 can include information relating to the beam of light and one or more LIDAR returns (e.g., measured time t between emitting beam and receiving of returned reflection from first and/or second targets, etc.).

In some aspects, ML model 420 can be trained to learn whether a matter is translucent or not based on secondary LIDAR returns. For example, ML model 420 can receive LIDAR sensor data 402 and output matter prediction 430 that predicts and/or detects a translucent or non-translucent matter. The ML model 420 can determine a distance difference (d) 410 (e.g., distance difference d between a position of first target 210 and a position of second target 220 as illustrated in FIG. 2) based on LIDAR sensor data 402 that provides information relating to primary/first return and secondary return. In some examples, the input to ML model 420 can be distance difference (d) 410 that is determined by LIDAR sensor model 202 as illustrated in FIG. 2.

In some examples, given the input (e.g., LIDAR sensor data 402 or distance difference (d) 410), ML model 420 can output matter prediction 430. For example, ML model 420 is trained to learn that if the distance difference (d) 410 is trivial (e.g., less than 2 cm) or zero, the first/primary return and the second/secondary return of a LIDAR beam are generated by reflecting from the same matter. As follows, ML model 420 can determine that a LIDAR beam is reflected from the surface of a non-translucent matter and has returned both the first/primary return and the second/secondary return. The ML model 420 may learn to ignore and consider the secondary return as noise. In some aspects, if the distance difference (d) 410 is non-trivial (e.g., longer than 2 cm), ML model 420 is trained to learn that the first/primary return and second/secondary return are reflections of different targets. As follows, ML model 420 may output matter prediction 430 that determines that a second target that is associated with the second/secondary return is a translucent matter.

FIG. 5 illustrates a flowchart illustrating an example process 500 for detecting a translucent matter based on LIDAR returns. Although the example process 500 depicts a particular sequence of operations, the sequence may be altered without departing from the scope of the present disclosure. For example, some of the operations depicted may be performed in parallel or in a different sequence that does not materially affect the function of process 500. In other examples, different components of an example device or system that implements process 500 may perform functions at substantially the same time or in a specific sequence.

At block 510, process 500 can include receiving at least two LIDAR returns associated with a LIDAR beam transmitted by a LIDAR device. The at least two LIDAR returns include a primary return including a first portion of the LIDAR beam reflected from a matter along a first path of the first portion of the LIDAR beam and a secondary return including a second portion of the LIDAR beam reflected from additional matter along a second path of the second portion of the LIDAR beam.

For example, LIDAR sensor model 202 or ML model 420 can receive two LIDAR returns such as first return 215 and second return 225 that are associated with a single LIDAR beam 206, which is transmitted by LIDAR sensor 204. The first return 215 may include a first portion of LIDAR beam 206A reflected from first target 210 along a first path of the first portion of LIDAR beam 206A. The second return 225 may include a second portion of LIDAR beam 206B reflected from second target 220 along a second path of the second portion of LIDAR beam 206B.

At block 520, process 500 can include determining a distance difference between a first position of the matter along the first path and a second position of the additional matter along the second path. As previously described, the second path is an extension of the first path (e.g., the first path and the second path follow the same angle from a LIDAR sensor). The first position is determined based on the primary return and the second position is determined based on the secondary return. For example, LIDAR sensor model 202 or ML model 420 can determine a distance difference (d) between a first position of first target 210 and a second position of second target 220. For example, the positions of first target 210 and second target 220 can be determined based on the travel time between emitting of LIDAR beam 206 and receiving the returned reflection(s).

At block 530, process 500 can include comparing the distance difference with a threshold. For example, LIDAR sensor model 202 or ML model 420 can compare the distance difference (d) with a threshold to determine whether second target 220 is a non-translucent matter or a translucent matter (e.g., vapor, steam, water splash, fog, rain, dust, a translucent object, etc.).

At block 540, process 500 can include determining whether the additional matter that generated the secondary return by reflecting the second portion of the LIDAR beam is a non-translucent matter or a translucent matter based on the comparison between the distance difference and the threshold. For example, LIDAR sensor model 202 or ML model 420 can determine whether second target 220 that generated second return 225 by reflecting the second portion of LIDAR beam 206B is a non-translucent matter or a translucent matter (e.g., vapor, steam, water splash, fog, rain, dust, etc.).

In some aspects, if the distance difference (d) is below the threshold, LIDAR sensor model 202 or ML model 420 may determine that second target 220 is a non-translucent matter. For example, if the distance difference (d) is trivial or zero, LIDAR sensor model 202 or ML model 420 may determine that first return 215 and second return 225 are likely generated by reflecting from the same matter. In some examples, LIDAR sensor model 202 or ML model 420 may disregard the point associated with second return 225 or regard the point as noise in a point cloud.

In some examples, if the distance difference (d) exceeds the threshold, LIDAR sensor model 202 or ML model 420 may determine that second target 220 is a translucent matter (e.g., vapor, steam, water splash, fog, rain, dust, etc.).

In some examples, process 500 can include, if LIDAR sensor model 202 determines that second target 220 is a translucent matter, transmitting an instruction to a computing system associated with an autonomous vehicle to drive through the translucent second target 220. For example, LIDAR sensor model 202 may, if second target 220 is a translucent matter, provide the information associated with the translucent second target 220 to local computing device 110 (e.g., perception stack 112, prediction stack 116, planning stack 118) or a control system associated with AV 102. For example, local computing device 110 may update a point cloud that is mapped based on primary LIDAR return(s) to indicate that second target 220 is a translucent matter. In some examples, local computing device 110 (e.g., planning stack 118) may adjust a planned path of AV 102 to include a road segment including second target 220. In some instances, a control system associated with AV 102 may adjust one or more navigation parameters of AV 102 to drive through the translucent second target 220.

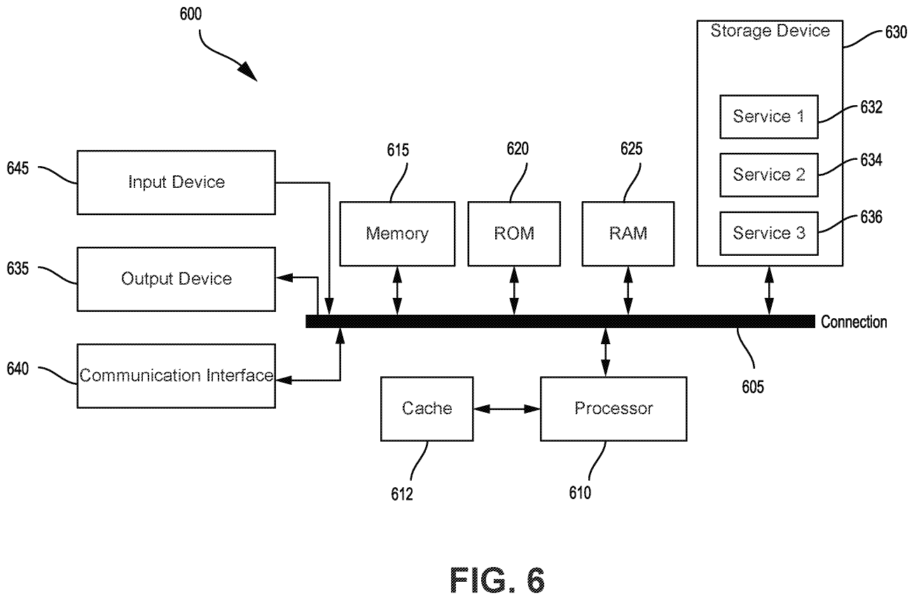

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communication interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a memory; and one or more processors coupled to the memory, the one or more processors being configured to: receive at least two light-based ranging sensor returns associated with a light-based ranging sensor beam transmitted by a light-based ranging sensor, wherein the at least two light-based ranging sensor returns include a primary return comprising a first portion of the light-based ranging sensor beam reflected from a matter along a first path of the first portion of the light-based ranging sensor beam and a secondary return comprising a second portion of the light-based ranging sensor beam reflected from additional matter along a second path of the second portion of the light-based ranging sensor beam; determine a distance difference between a first position of the matter along the first path and a second position of the additional matter along the second path, the first position being determined based on the primary return and the second position being determined based on the secondary return; compare the distance difference with a threshold; and based on the comparison between the distance difference and the threshold, determine whether the additional matter that generated the secondary return by reflecting the second portion of the light-based ranging sensor beam is a non-translucent matter or a translucent matter.

Aspect 2. The system of Aspect 1, wherein the light-based ranging sensor is a light detection and ranging (LIDAR) or a Time-of-Flight sensor.

Aspect 3. The system of Aspects 1 or 2, wherein determining whether the additional matter is the non-translucent matter or the translucent matter based on the comparison between the distance difference between and the threshold comprises: in response to determining that the distance difference is below the threshold, determining that the additional matter is the non-translucent matter.

Aspect 4. The system of any of Aspects 1 to 3, wherein determining whether the additional matter is the non-translucent matter or the translucent matter based on the comparison between the distance difference between and the threshold comprises: in response to determining that the distance difference exceeds the threshold, determining that the additional matter is the translucent matter.

Aspect 5. The system of any of Aspects 1 to 4, wherein the one or more processors are configured to: in response to determining that the additional matter is the translucent matter, transmit a message to a computing system associated with an autonomous vehicle indicating that the additional matter is translucent.

Aspect 6. The system of any of Aspects 1 to 5, wherein the primary return has a higher signal intensity than the secondary return.

Aspect 7. The system of any of Aspects 1 to 6, wherein the translucent matter includes at least one of vapor, steam, water splash, fog, rain, a translucent object, and dust.

Aspect 8. The system of any of Aspects 1 to 7, wherein the light-based ranging sensor beam is emitted by a LIDAR sensor mounted on an autonomous vehicle.

Aspect 9. A method comprising: receiving at least two light-based ranging sensor returns associated with a light-based ranging sensor beam transmitted by a light-based ranging sensor, wherein the at least two light-based ranging sensor returns include a primary return comprising a first portion of the light-based ranging sensor beam reflected from a matter along a first path of the first portion of the light-based ranging sensor beam and a secondary return comprising a second portion of the light-based ranging sensor beam reflected from additional matter along a second path of the second portion of the light-based ranging sensor beam; determining a distance difference between a first position of the matter along the first path and a second position of the additional matter along the second path, the first position being determined based on the primary return and the second position being determined based on the secondary return; comparing the distance difference with a threshold; and based on the comparison between the distance difference and the threshold, determining whether the additional matter that generated the secondary return by reflecting the second portion of the light-based ranging sensor beam is a non-translucent matter or a translucent matter.

Aspect 10. The method of Aspect 9, wherein the light-based ranging sensor is a light detection and ranging (LIDAR) or a Time-of-Flight sensor.

Aspect 11. The method of Aspects 9 or 10, wherein determining whether the additional matter is the non-translucent matter or the translucent matter based on the comparison between the distance difference between and the threshold comprises: in response to determining that the distance difference is below the threshold, determining that the additional matter is the non-translucent matter.

Aspect 12. The method of any of Aspects 9 to 11, wherein determining whether the additional matter is the non-translucent matter or the translucent matter based on the comparison between the distance difference between and the threshold comprises: in response to determining that the distance difference exceeds the threshold, determining that the additional matter is the translucent matter.

Aspect 13. The method of any of Aspects 9 to 12, further comprising: in response to determining that the additional matter is the translucent matter, transmit an instruction to a computing system associated with an autonomous vehicle to drive through the translucent matter.

Aspect 14. The method of any of Aspects 9 to 13, wherein the primary return has a higher signal intensity than the secondary return.

Aspect 15. The method of any of Aspects 9 to 14, wherein the translucent matter includes at least one of vapor, steam, water splash, fog, rain, and dust.

Aspect 16. The method of any of Aspects 9 to 15, wherein the LIDAR beam is emitted by a LIDAR sensor mounted on an autonomous vehicle.

Aspect 17. A non-transitory computer-readable medium comprising instructions which, when executed by one or more processors, cause the one or more processors to perform a method according to any of Aspects 9 to 16.

Aspect 18. A system comprising means for performing a method according to any of Aspects 9 to 16.

Aspect 19. The system of Aspect 18, wherein the system comprises an autonomous vehicle.

Aspect 20. A computer-program product including instructions which, when executed by one or more processors, cause the one or more processors to perform a method according to any of Aspects 9 to 16.

What is claimed is:

1. A system comprising:
a memory; and
one or more processors coupled to the memory, the one or more processors being configured to:
receive at least two light detection and ranging (LIDAR) returns associated with a LIDAR beam transmitted by a LIDAR device, wherein the at least two LIDAR returns include a primary return comprising a first portion of the LIDAR beam reflected from a matter along a first path of the first portion of the LIDAR beam and a secondary return comprising a second portion of the LIDAR beam reflected from additional matter along a second path of the second portion of the LIDAR beam;
determine a distance difference between a first position of the matter along the first path and a second position of the additional matter along the second path, the first position being determined based on the primary return and the second position being determined based on the secondary return;
compare the distance difference with a threshold; and
based on the comparison between the distance difference and the threshold, determine whether the additional matter that generated the secondary return by reflecting the second portion of the LIDAR beam is a non-translucent matter or a translucent matter.

2. The system of claim 1, wherein determining whether the additional matter is the non-translucent matter or the translucent matter based on the comparison between the distance difference between and the threshold comprises:
in response to determining that the distance difference is below the threshold, determining that the additional matter is the non-translucent matter.

3. The system of claim 1, wherein determining whether the additional matter is the non-translucent matter or the translucent matter based on the comparison between the distance difference between and the threshold comprises:
in response to determining that the distance difference exceeds the threshold, determining that the additional matter is the translucent matter.

4. The system of claim 1, wherein the one or more processors are configured to:
in response to determining that the additional matter is the translucent matter, transmit a message to a computing system associated with an autonomous vehicle indicating that the additional matter is translucent.

5. The system of claim 1, wherein the primary return has a higher signal intensity than the secondary return.

6. The system of claim 1, wherein the translucent matter includes at least one of vapor, steam, water splash, fog, rain, a translucent object, and dust.

7. The system of claim 1, wherein the LIDAR beam is emitted by a LIDAR sensor mounted on an autonomous vehicle.

8. A method comprising:
receiving at least two light detection and ranging (LIDAR) returns associated with a LIDAR beam transmitted by a LIDAR device, wherein the at least two LIDAR returns include a primary return comprising a first portion of the LIDAR beam reflected from a matter along a first path of the first portion of the LIDAR beam and a secondary return comprising a second portion of the LIDAR beam reflected from additional matter along a second path of the second portion of the LIDAR beam;
determining a distance difference between a first position of the matter along the first path and a second position of the additional matter along the second path, the first position being determined based on the primary return and the second position being determined based on the secondary return;
comparing the distance difference with a threshold; and
based on the comparison between the distance difference and the threshold, determining whether the additional matter that generated the secondary return by reflecting the second portion of the LIDAR beam is a non-translucent matter or a translucent matter.

9. The method of claim 8, wherein determining whether the additional matter is the non-translucent matter or the translucent matter based on the comparison between the distance difference between and the threshold comprises:
in response to determining that the distance difference is below the threshold, determining that the additional matter is the non-translucent matter.

10. The method of claim 8, wherein determining whether the additional matter is the non-translucent matter or the translucent matter based on the comparison between the distance difference between and the threshold comprises:
in response to determining that the distance difference exceeds the threshold, determining that the additional matter is the translucent matter.

11. The method of claim 8, further comprising:
in response to determining that the additional matter is the translucent matter, transmit an instruction to a computing system associated with an autonomous vehicle to drive through the translucent matter.

12. The method of claim 8, wherein the primary return has a higher signal intensity than the secondary return.

13. The method of claim 8, wherein the translucent matter includes at least one of vapor, steam, water splash, fog, rain, and dust.

14. The method of claim 8, wherein the LIDAR beam is emitted by a LIDAR sensor mounted on an autonomous vehicle.

15. A non-transitory computer-readable medium comprising instructions which, when executed by one or more processors, cause the one or more processors to:
receive at least two light detection and ranging (LIDAR) returns associated with a LIDAR beam transmitted by a LIDAR device, wherein the at least two LIDAR returns include a primary return comprising a first portion of the LIDAR beam reflected from a matter along a first path of the first portion of the LIDAR beam and a secondary return comprising a second portion of the LIDAR beam reflected from additional matter along a second path of the second portion of the LIDAR beam;
determine a distance difference between a first position of the matter along the first path and a second position of the additional matter along the second path, the first position being determined based on the primary return and the second position being determined based on the secondary return;
compare the distance difference with a threshold; and
based on the comparison between the distance difference and the threshold, determine whether the additional matter that generated the secondary return by reflecting the second portion of the LIDAR beam is a non-translucent matter or a translucent matter.

16. The non-transitory computer-readable medium of claim 15, wherein determining whether the additional matter is the non-translucent matter or the translucent matter based on the comparison between the distance difference between and the threshold comprises:
in response to determining that the distance difference is below the threshold, determining that the additional matter is the non-translucent matter.

17. The non-transitory computer-readable medium of claim 15, wherein determining whether the additional matter is the non-translucent matter or the translucent matter based on the comparison between the distance difference between and the threshold comprises:
in response to determining that the distance difference exceeds the threshold, determining that the additional matter is the translucent matter.

18. The non-transitory computer-readable medium of claim 15, comprising further instructions configured to cause the one or more processors to:
in response to determining that the additional matter is the translucent matter, transmit an instruction to a computing system associated with an autonomous vehicle to drive through the translucent matter.

19. The non-transitory computer-readable medium of claim 15, wherein the primary return has a higher signal intensity than the secondary return.

20. The non-transitory computer-readable medium of claim 15, wherein the translucent matter includes at least one of vapor, steam, water splash, fog, rain, and dust.
